(19) United States
(12) Patent Application Publication
(10) Pub. No.: US 2012/0240870 A1
(43) Pub. Date: Sep. 27, 2012

(54) CIRCULATING FLUIDIZED BED BOILER WITH GAS-SOLID SEPARATOR

(76) Inventor: Sen Wang, Shijiazhuang (CN)

(21) Appl. No.: 13/261,103

(22) PCT Filed: Nov. 28, 2011
(86) PCT No.: PCT/CN2011/083017

§ 371 Date: Dec. 23, 2011

(30) Foreign Application Priority Data
Dec. 5, 2010 (CN) 201010572936.3
Feb. 12, 2011 (CN) 201110036996.8

(51) Int. Cl. F23C 10/10; B01D 45/02; F28D 13/00

(52) U.S. Cl. 122/4 D; 165/104.16; 110/234; 95/272

(57) ABSTRACT

A gas-solid separator for a boiler includes a film divider defining first and second flue channels, an expanded cornering channel, a sealed collecting chamber, flue inlet and outlet provided at a front upper portion and a rear upper portion of the separator respectively, an even flow distributing tube set, and wear resistant connecting duct at the cornering channel, the upper and bottom portions of the even flow distributing tube set linked to the film bottom transverse tube collecting box and the collecting chamber transverse tube collecting box respectively, the upper and bottom portions of the wear resistant connecting duct linked to the film bottom transverse tube collecting box and the connecting duct transverse tube collecting box respectively. The boiler with low/medium circulating rate uses single stage inertial gravity separation. The boiler with high circulating rate uses a low temperature cyclone separator with the present invention when the flow rate at the second flue channel is relatively high.

### BACKGROUND OF THE PRESENT INVENTION

1. Field of Invention

The present invention relates to a gas-solid separator of circulating fluidized bed boiler as one of the key components thereof, wherein the gas-solid separator does not require any specific installing device or separating component to incorporate with the fluidized bed boiler, wherein the gas-solid separator is configured to have a first flue channel, a second flue having a fume direction different from a fume direction of the first flue channel, and an expanded cornering channel, and a collecting chamber, wherein the gas-solid separator is integrally formed at a space adjacent to a heat surface of the boiler to form an inertia-gravity gas-solid separator. In particular, the novel gas-solid separator is designed and is adapted to incorporate with different types of circulating fluidized bed boiler or other chain combustion boiler for energy saving and emission reduction.

2. Description of Related Arts

A circulating fluidized bed boiler combustion is a combustion technology having the benefits of highly adaptability, high combustion efficiency, low emission of nitric oxides, high efficiency of removing sulfur in a simple manner, and high efficiency of achieving during combustion and load regulation. Therefore, the circulating fluidized bed boiler is considered as one of the “clean” boiler to control pollutant emissions.

The boiler is one of the important thermal power equipments in a country, wherein the boiler is widely used in electrical industry, mechanical industry, metallurgic industry, chemical industry, textile industry, food industry, commercial heating industry, etc., wherein the boiler is extremely important in human lives.

Statistics show that China used 2.58 billion tons of coal in 2007, wherein the boiler used 2.2 billion tons of coal, which was 85.3% of the total coal usage. China is the number one spot for the world's most sulfur dioxide emitting country for many years. Energy saving and environmental friendly issue are included in the fundamental national policies in China. In particular, the construction of the coal type boilers is the number one project of the top ten energy-saving lists in China. According to the energy sustainable development in China, coal as the major fuel cannot be simply replaced in the coming decades, such that China is searching a feasible plan to reduce the carbon emission and to save energy in economy and industry. Therefore, the development of the existing boiler and the improvement the boiler combustion technology will be the major breakthrough in response to global climate change policies and practices.

Unlike the existing boiler, the circulating fluidized bed boiler has the advantages of desulfurization, denitrification, and energy-saving. It will be the significant influence with the reduction of energy consumption in the world when the technology of the circulating fluidized bed boiler can be further improved. The circulating fluidized bed boiler not only has the advantage of high coal adaptability but also has an unique advantage for biomass power generation and power generation from municipal solid waste incineration. In addition, the circulating fluidized bed boiler not only has the advantages of the traditional industrial boiler but also has the advantage of new energy generation.

The circulating fluidized bed gas-solid separator is the key component of the circulating fluidized bed boiler, wherein the gas-solid separator is arranged to separate solids from a large amount of high temperature incoming mixture of gas and solid particles and to return the gas back to the air chamber. The gas-solid separator also maintains the combustion chamber in a rapid fluidization manner and ensures the fuel and desulfurizer being kept cycling to repeatedly combust and react, so as to achieve the desired efficiency of combustion and desulfurization. In other words, the gas-solid separator will directly affect the performance of the circulating fluidized bed boiler. Generally speaking, the operation mode and the service life span of gas-solid separator are the sign to indicate the performance of the circulating fluidized bed boiler. Therefore, the performance of the circulating fluidized bed boiler will depend on the performance of the gas-solid separator while the developmental milestone of the circulating fluidized bed boiler will depend on the development of the gas-solid separation technology.

Currently, the most popular gas-solid separator being utilized in domestic and international markets is the high temperature cyclone type of separator which has a major advantage of high separation efficiency rate. On the other hand, the high temperature cyclone type of separator has the following disadvantages of bulky size, high wind velocity and high resistance at the tangent air inlet, and high electrical consumption of the induced fan. The high speed flue gas with gas and solid particles will carry a large amount of fly ash when the flue gas flows at the opposite direction of the collecting chamber. The concentration of the original fume emission is relatively high. The separator requires inner and outer heat insulation layers and requires relatively large amount of wear-resistant and high temperature resistant materials for construction, so as to not only highly increase the raw material cost, the manufacturing cost, and the installation cost of the separator. In addition, the separator has high thermal inertia and high temperature coke formation, and will cause the slow startup and shut down of the boiler. Some boilers unitizes the cooled water or cooled air type separator to minimize the use of wear-resistant and high temperature resistant materials and to reduce the thermal inertia, such that the coke formation within the boiler will be reduced and the boiler can be started and shut down quickly. However, the problems of high wind velocity, and high resistance at the tangent air inlet, and high electrical consumption of the induced fan are unsolved. The separation efficiency and the stability of the cooled water or cooled air type separator is lower than those of the separators made of high temperature resistance material. The manufacturing process of the cooled water or cooled air type separator is relatively complicated and the cost thereof is relatively high. Therefore, the cooled water or cooled air type separator is hard to be accepted in the existing market.

Although China Patent Application number 200910308160.1 discloses the gas-solid separator of the circulating fluidized bed boiler has many advantages compared to the high temperature cyclone type separator, such as low wind resistance, low electrical consumption, utilization of water-cooled membrane wall structure to reduce the use of wear-resistant and high temperature materials. However, the gas-solid separator has several drawbacks. For example, there is no blockage at the inlet and outlet of the turning channel. Firstly, the inertial separation performance is poor. Secondly, there is no water-cooled wall structure provided at two sidewalls of the collecting chamber such that the service life span of the separator will be shortened and the maintenance cost of the separator will be highly increased. Thirdly, the integration of the separator into the boiler structure is relatively difficult and the separator is not compatible with the geometric configuration of the boiler so as to limit the usage expansion for a large scale of boiler.

### SUMMARY OF THE PRESENT INVENTION

The invention is advantageous in that it provides a gas-solid separator for circulating fluidized bed boiler to solve the existing technical problems thereof, in order to save energy, to reduce energy loss, to significantly reduce the emission, to expanse the applicable range, to enhance he advanced combustion technology, to significantly save the material use, and to greatly improve the performance of the gas-solid separator as well as the boiler incorporating with the gas-solid separator.

According to the present invention, the foregoing and other objects and advantages are attained by a gas-solid separator incorporated with a circulating fluidized bed boiler without any installing device or separating component, wherein the gas-solid separator does not require any non-boiler heating surface made of wear resistant and high temperature resistant material for the cyclone type separator and does not require any non-boiler heating surface separating component made of special steel for various inertial separator. The gas-solid separator of the present invention is located at the inherent heating compartment adjacent to the heating surface of the boiler to form an inertial gravity separator, wherein the gas-solid separator is arranged to efficiently proceed the gas-solid separation through the dramatically change of the flue direction, the deceleration of the flue speed at the expanded cornering channel, and the understanding the flow pattern and speed to detour and regulate the flue direction and speed.

The gas-solid separator comprises a first flue channel, a second flue channel, an expanded cornering channel, and a collecting chamber which are located at a separator space between the rear wall of the boiler furnace and the front wall of the vertical tunnel, wherein the separator space is configured to be concealed by a film type water-cooled wall or water cooled wall made of heat resistant material. The flow of flue at the first flue channel, the second flue channel, the expanded cornering channel is regulated at different flow rates in order to increase the flow rate of flue at the first flue channel, to reduce the flow rate of flue at the expanded cornering channel, to enhance the inertial separation force and gravitational precipitation force of the solid particles, and to reduce the flow rate at the second flue channel for minimizing the solid particles being dragged by the flow of flue at the second flue channel. Therefore, the fine solid particles will not be dragged again into the flue when the flow of flue is guided along the second flue channel.

The flue with fine solid particles is guided by the film divider to detour the flue direction from the flue outlet of the boiler furnace to the first flue channel. Preferably, the flue direction at the boiler furnace is vertically upward direction and the flue direction at the first flue channel is vertically downward direction, such that the flue direction is rapidly turned 180° from the boiler furnace to the first flue channel. In particular, the flue is forced to rapidly straight down along the first flue channel to the collecting chamber. The high concentrated solid particles are initially separated from the flue by the effects of the centrifugal force generated by the sharp turning direction and the gravitational pulling force. Thus, the efficiency of inertial gravity separation for the gas-solid separation will be further enhanced by the flow propelling force and the gravitational force of the solid particles to rapidly drop the solid particles into the collecting chamber. Since the cross section of the expanded cornering channel is larger than, preferably three times larger, the cross section of the first flue channel, the flow rate of the flue will be dramatically reduced when entering to the expanded cornering channel. Therefore, the solid particles in the flue at the slow flow rate will be substantially precipitated into the collecting chamber by gravity. Accordingly, the flue direction of flue is rapidly turned at the gas-solid separator two times, preferably two 180° sharp turns, to separate the solid particles from the flue by inertial separation so as to precipitate the solid particles at the collecting chamber. The flue will also multiply strike against the even flow distributing tube sets to separate the solid particles from the flue by inertial separation so as to precipitate the solid particles at the collecting chamber. Preferably, the flow rate of flue at the first flue channel is equal or lesser than 3 m/s, such that the dragging force of the flue at the second flue channel will have minimum effect to drag the solid particles back from the collecting chamber to the second flue channel. In addition, the path length of the first flue channel, the second flue channel, the expanded cornering channel, and the collecting chamber matches with the height of the boiler furnace for prolonging the combustion time of the flue, such that the flue with the minimum solid particles has no circulating combustion value when the flue exhausts at the second flue channel.

To improve the above mentioned existing combustion technology for overcoming the shortcomings thereof, the present invention provides a novel gas-solid separator and a boiler with the novel gas-solid separator.

According to the present invention, the gas-solid separator, for a circulating fluidized bed boiler, comprises a film divider, a first flue channel, a second flue channel, a cornering channel, and a collecting chamber, wherein a flue inlet is provided at the front upper portion of the gas-solid separator, wherein a flue outer is provided at the rear upper portion of the gas-solid separator. The film divider is formed at the separator space to divide the separator space into the first flue channel and the second flue channel, wherein the first flue channel is communicated with the second flue channel through the cornering channel, wherein the bottom portion of the cornering channel is operatively linked to and sealed with the collecting chamber, wherein the bottom portion of the collecting chamber is operatively linked to the dipleg via the feedback valve.

In accordance with another aspect of the invention, the present invention comprises a boiler which comprises a boiler furnace, a gas-solid separator, and a vertical tunnel, wherein the flue inlet of the gas-solid separator is operatively linked to the upper portion of the boiler furnace while the flue outlet of the gas-solid separator is operatively linked to the upper portion of the vertical tunnel, wherein the dipleg is operatively linked to the bottom portion of the boiler furnace.

In accordance with another aspect of the invention, the present invention comprises a gas-solid separation method which comprises the steps of configuring three flowing paths as the first flue channel, the second flue channel, and the cornering channel, regulating different flow rates of the flue at the three flowing paths, increasing the flow rate of flue at the first flue channel, expanding a flow area of the expanded cornering channel with respect to the first flue channel to decelerate the flow rate of flue at the expanded cornering channel so as to enhance the inertial separation force and gravitational precipitation force of the solid particles within the flue, and minimizing said flow rate at the second flue channel for minimizing the solid particles being dragged by the flow of flue at the second flue channel. Therefore, the fine solid particles will not be dragged again into the flue when the flow of flue is guided along the second flue channel. The film divider is arranged for guiding said flue with solid particles to detour the flue direction from the flue outlet of the boiler furnace to the first flue channel. Preferably, the flue direction at the boiler furnace is vertically upward direction and the flue direction at the first flue channel is vertically downward direction, such that the flue direction is rapidly turned 180° from the boiler furnace to the first flue channel. In particular, the flue is forced to rapidly straight down along the first flue channel to the collecting chamber at the bottom portion of said cornering channel. Since the cross section of the expanded cornering channel is larger than the cross section of the first flue channel, the flow rate of the flue will be dramatically reduced when entering to the expanded cornering channel. Therefore, the high density of solid particles in the flue at the slow flow rate will be substantially precipitated into the collecting chamber by gravity. Accordingly, the flue direction of flue is rapidly turned at the gas-solid separator twice, preferably two 180° sharp turns, to separate the solid particles from the flue by inertial separation so as to precipitate the solid particles at the collecting chamber.

The present invention further contains the following distinctive features.

The gas-solid separator further comprises an even flow distributing tube set defined at the bottom portion of the film divider.

The even flow distributing tube set is provided at the cornering channel, wherein the even flow distributing tube set can provide at one side or two sides of the film divider to form the flue inlet and/or the flue outlet of the cornering channel. The upper portion of the even flow distributing tube set is operatively linked to the film divider while the bottom portion of the even flow distributing tube set is operatively linked to either the collecting chamber bottom transverse tube collecting box or the tube set bottom transverse tube collecting box within the cornering channel, wherein the collecting chamber bottom transverse tube collecting box is operatively linked to the down flowing duct of the boiler.

The film divider is configured to form the single row tube set, wherein the bottom portion of the single row tube set of the film divider is bifurcated to form a front row tube set having two or more rows of tube sets, and a rear row tube set having two or more rows of tube sets. The front and rear rows tube sets are evenly extended above the collecting chamber to form the flue inlet and flue outlet of the cornering channel. In addition, the front and rear rows tube sets are also formed as the even flow distributing tube sets at the flue inlet and flue outlet of the cornering channel. The front row tube set is frontwardly and inclinedly extended to the rear wall of the boiler furnace. The multiple rows of the front row tube set will be merged into a single row and will be vertically bent to form a front vertical tube set. The rear row tube set is rearwardly and inclinedly extended to the front wall of the vertical tunnel. The multiple rows of the rear row tube set will be merged into a single row and will be vertically bent to form a rear vertical tube set. The bottom portion of the rear vertical tube set is inwardly bent to further rearwardly extend that the bottom portion thereof is operatively linked to the collecting chamber bottom transverse tube collecting box. The bottom portion of the rear vertical tube set forms the inclined tube set as the collecting chamber tube wall, such that the collecting chamber tube wall is integrally formed with the rear vertical tube set.

The gas-solid separator further comprises a film bottom transverse tube collecting box at the bottom portion of the film divider, wherein the film divider is operatively linked to the film bottom transverse tube collecting box. The gas-solid separator further comprises a film upper transverse tube collecting box at the upper portion of the film divider, wherein the film divider is operatively linked to the film upper transverse tube collecting box. The upper portion of the even flow distributing tube set within the cornering channel is operatively linked to the film bottom transverse tube collecting box.

The upper portion of the even flow distributing tube set at the flue outlet of the second flue channel is operatively linked to the film upper transverse tube collecting box or the upper transverse tube collecting box at the upper side of the gas-solid separator. The upper transverse tube collecting box is operatively linked to the fuel guiding duct of the boiler. The bottom portion of the even flow distributing tube set at the flue outlet of the second flue channel is biased against the front wall of the vertical tunnel or the bottom portion of the even flow distributing tube set is spaced apart from the front wall of the vertical tunnel to form a downwardly vertical tube set. The bottom portion of the downwardly vertical tube set is inwardly bent to form the inclined tube set as the collecting chamber wall tube. The inclined tube set of the collecting chamber wall tube is operatively linked to the collecting chamber bottom transverse tube collecting box.

The film divider is formed at the separator space at a position according to the need of the boiler. The film divider can be provided at the middle of the rear wall of the boiler furnace and the front wall of the vertical tunnel, or the film divider can be either located slightly close to the rear wall of the boiler furnace or located significantly close to the rear wall of the boiler furnace.

Accordingly, when the flow rate of the flue at the first flue channel is greater than 5 m/s, the wear resistant connecting tube is used for the even flow distributing tube set at the cornering channel.

The film divider and the four surrounding walls of the gas-solid separator can be a full membrane wall structure, a half membrane wall structure, a partial membrane wall structure, a full light tube heat resistant drywall structure, or a heat resistant drywall structure.

The interior and/or exterior shape of the gas-solid separator can be rectangular, square, circular, oval, or polygonal shape.

The front wall of the gas-solid separator is integrally formed at the rear wall of the boiler furnace, or is an individual film membrane wall structure or a water cooled wall structure. The rear wall of the gas-solid separator is integrally formed at the front wall of the vertical tunnel, or is an individual film membrane wall structure or a water cooled wall structure. The two sidewalls of the gas-solid separator are two symmetrical film membrane wall structures or two symmetrical water-cooled walls, wherein the upper and bottom portions of the sidewalls are extended from the two symmetrical upper longitudinal tube collecting boxes to the two symmetrical bottom longitudinal tube collecting boxes. The upper symmetrical longitudinal tube collecting boxes are linked to the fuel guiding duct of the boiler. The bottom longitudinal tube collecting boxes are linked to the down flowing duct of the boiler.

The objectives of the present invention are that: the present invention provides revolutionary formation of the gas-solid separator in all fields, wherein the present invention not only contains advanced technology but also simplifies the manufacturing process of the gas-solid separator to the boiler. It, can significantly save energy, reduce flue emission, improve the overall energy efficiency, prolong the service life span of the boiler, and provide many other breakthrough in configuration of the gas-solid separator. The present invention can solve two problems of high temperature coke formation by the low burning point of the biomass and municipal solid waste and the high temperature corrosion of the boiler, such that the development of the present invention is the first objective in the new energy industry. In particular, the average circulating rate of the gas-solid separator is lesser than 5 m/s, which is a low flow resistance, and is at least 4 times lesser than the conventional cyclone type separator, wherein the motor fan can save 10% to 30% of electrical consumption when incorporating with the present invention. Therefore, the second objective of the present invention is to save energy in long term. The front wall of the gas-solid separator is integrally formed at the rear wall of the boiler furnace while the rear wall of the gas-solid separator is integrally formed at the front wall of the vertical tunnel. In other words, the material of the front and rear walls of the gas-solid separator can be significantly saved no matter how big is the boiler. Therefore, the gas-solid separator will not require two sidewalls and the film divider to fit any size of the boiler. On the other hand, the conventional cyclone type separator is an individual separator that the number of the conventional cyclone type separator will be increased when a bigger size of boiler is used. According to the present invention, the material use of the gas-solid separator is about the same or even lesser than the material use of the conventional cyclone type separator. One of the conventional cyclone type separators can be used in the boiler while the rest of the conventional cyclone type separators can be replaced by the gas-solid separators of the present invention. In other words, the more the conventional cyclone type separators are used in the boiler, the less the material use for the boiler can be reduced by replacing the conventional cyclone type separators by the present invention. The gas-solid separator of the present invention utilizes the water cooled wall structure for inertial separation such that the wear resistant treatment will only be applied 30% of the total area of the first flue channel, wherein the thickness of the wall of the first flue channel is about 50 mm and the flue rate at the first flue channel is about 7 m/s. However, the wear resistant treatment will be applied 100% of the total area of the conventional cyclone type separator, wherein the wall thickness of the conventional cyclone type separator is about 300 mm to 500 mm for heat insulation. The most thickness of the wall of the conventional cyclone type separator can be 800 mm. the flow rate is about 25 m/s for the conventional cyclone type separator. It is obvious that the material use and the wear resistant difference between the conventional cyclone type separator and the gas-solid separator of the present invention. Therefore, by significantly reducing the material use for wear resistance and heat insulation, the overall weight of the present invention will be substantially reduced to minimize the stainless steel made supporting frame for frame support. In other words, the third objective of the present invention is to minimize the material use of the gas-solid separator. Preferably, the flue direction is rapidly turned 180° from the flue outlet of the boiler furnace to the first flue channel toward the collecting chamber. In particular, the flue direction of flue is rapidly turned at the gas-solid separator two times, preferably two 180° sharp turns, to separate the solid particles from the flue by inertial separation, while the flue flow will also multiply strike to the multiple row tube sets to separate the solid particles from the flue by inertial separation. The flue rate at the first flue channel is about 5 m/s to 7 m/s and dramatically changes to 1.5 m/s to 2.5 m/s at the expanded cornering channel, such that the deceleration of the flow rate of the flue at the expanded cornering channel will effectively precipitate the solid particles in the flue at the collecting chamber by means of inertial gravity. Since the flow rate at the cornering channel is smaller than the flow rate at the second flue channel, the flue flow will not create any vortex like motion at the cornering channel while the solid particles in the flue can be further precipitated downward when the flue is guided to flow at the second flue channel. The flow rate at the second flue channel is equal or lesser than 3 m/s such that the fine solid particles will not be significantly carried by the flue at the second flue channel. The concentration of flue emission is expected close to that of the chain combustion boiler that the present invention can reach the national environmental emission standards. Therefore, the fourth objective of the present invention is to provide the gas-solid separator having relatively high gas-solid separation efficiency comparing with the conventional cyclone type separator. The first flue channel, the second flue channel, and the expanded cornering channel form a combustion chamber for complete combustion, such that the present invention will substantially add an additional combustion chamber matching the height of the boiler furnace for prolonging the combustion time of the flue. Therefore, the fifth objective of the present invention is to minimize the amount of solid particles and the carbon content in the flue. The present invention has an advanced technology and no complicated or irregular component, and is suitable for a boiler ≧35 T, wherein the gas-solid separator, the ceiling of the boiler, and the vertical tunnel can be configured to have a full membrane wall structure or water cooled non-drywall structure. Thus, the maintenance of the gas-solid separator and the boiler is simple to prolong the service life span of the gas-solid separator and the boiler. The startup and shut off response time for the boiler is quick, there is no coke formation in the boiler, and the load regulation is selectively adjustable. These features are the sixth advantage of the present invention. The seventh advantage of the present invention is to substantially reduce the solid particles in the flue, to reduce the ash accumulation at the exit of the boiler, to minimize the wear and tear of the boiler, to enhance the ash cleaning process of the boiler, to enhance the heat transfer efficiency, to save energy at different view points, and to enhance the overall performance of the boiler. The gas-solid separator can be integrated with the boiler as part of the boiler's structure to completely change the existing large scale circulating fluidized bed boiler design which is the modularization or enlargement design, such that the present invention is adapted to reduce the operation cost of the boiler and to lower the material cost and manufacturing cost of the boiler. Therefore, the eighth objective of the present invention is to enhance the development of the large scale circulating fluidized bed boiler and to create a competitive boiler structure for the power generation system in the market and the large scale coal powered power plant.

According to the present invention, the path length of the first flue channel, the second flue channel, and the expanded cornering channel, form an combustion chamber matching with the height of the boiler furnace for prolonging the combustion time of the flue, so as to solve the thermal efficiency of the boiler with <351 due to the limited height of the boiler. Especially for the transverse double drum type boiler with <35 T, the full water cooled wall type separator increases the heating surface thereof and configures the location of the heating surface, such that the present invention can utilize the space in height of the boiler for regulating the flow rate of flue and the flow path of the flue, and for increasing the flow rate of flue at the returning path. For the boiler with low steam temperature, the boiler can be configured to have an air preheating device to omit the vertical tunnel and the coal economizer. For the boiler with high steam temperature, the vertical tunnel can be configured in half size. The gas-solid flue is guided to flow upward along the convection tube set to minimize the solid particles or ash being accumulated at the convection channel and the heating surface. The average flow rate of flue at the gas-solid separator is relatively low and the gas-solid separator can precisely control and regulate the flow direction of the flue, the flow rates of the flue at different channels and the angle of the divider within the convection channel, such that the concentration of flue emission can reach the national emission standards for environmental protection. The advantages of the present invention are to significantly improve the performance of the small boiler, to solve the investment and economic drawbacks of the exiting boilers, and to provide an energy saving and environmental friendly boiler as a replacement of the conventional chain combustion boiler.

The present invention is significantly suitable for the boiler with high circulating rate. Since the large scale boiler has relatively bigger interior room to configure the cornering channel in order to provide enough space for the expanded cornering channel. The goal of the present invention can be simply achieved by selectively regulating the flow rates of flue at the first and second flue channels and the depth of the cornering channel. The path of the flow of flue from the first flue channel to the second flue channel through the cornering channel is configured as the entire space of the combustion chamber to minimize the solid particles or ash content in the flue, such that the flue with the minimum solid particles has no circulating combustion value when the flue exhausts at the second flue channel. When the flow rate of flue at the second flue channel is relatively high, a two-step low temperature cyclone separator can be setup at the vertical tunnel at a position away from the dipleg with respect to the inclination angle thereof to enable the bottom portion of the dipleg communicating with rear portion the feedback valve or the rear upper portion of the feedback valve. Since the one-step low temperature cyclone separator has higher efficiency, the two-step low temperature cyclone separator has relatively low separation efficiency to affect the combustion temperature of the boiler furnace by the low temperature separator. Therefore, the concentration of flue emission of the present invention is expected close to that of the chain combustion boiler that the present invention can reach the national environmental emission standards to provide a breakthrough in low flue emission.

It is obvious that the inertial separator of the circulating fluidized bed boiler cannot be simply replaced by the high temperature cyclone separator even though the chamber size of the boiler is larger than the size of the high temperature cyclone separator. It is because the larger drum wall of the high temperature cyclone separator must be thickened by the wear resistant and high thermal insulated material and the distance between the inlet and the outlet of the high temperature cyclone separator is limited. The present invention provides the unique features of the front wall of the gas-solid separator is integrally formed at the rear wall of the boiler furnace, the rear wall of the gas-solid separator is integrally formed at the front wall of the vertical tunnel the front row convection tube set, and the prolonged path of the flue from the first flue channel to the second flue channel through the expanded cornering channel to reduce the temperature of the boiler. Therefore, the present invention can substantially replace the high temperature cyclone separator by simply regulating the flow direction of the flue, by regulating the flow rates at different channels, and adjusting the size of the expanded cornering channel. Accordingly, the present invention provides significantly advantages to save electrical energy, to reduce the wear resistant material use, to minimize the solid particles or ash-carbon content, to lower the concentration of flue emission, to lower the wear and tear of the boiler, to extend the service life span of the boiler, to enhance the gas-solid separation efficiency, to reduce the coke formation, and to enhance the rapid startup and shut off operation of the boiler. The features of energy saving and low emission of the present invention do not depend on its size. Therefore, the present invention can incorporate with different types of boilers.

The present invention is operated according to the principle of inertial separation, in response to the flow rate of flue at 3-5 m/s for natural precipitation, to the substantial area expansion of the cornering channel for gravitational precipitation, to the flow rate equals or smaller than 5 m/s for preventing the wear and tear of the heating surface, to the flow rate equals or smaller than 3M for minimizing the drag of the fine solid particles, and to the flow rate equals or smaller than 1.5M for preventing the drag of the fine solid particles. The present invention not only fulfills the above principles but also is adapted to facilitate the full and effective implementation. The present invention is not limited by the above data and is adapted to be selectively adjusted practically according to different data and situations. Still further objects and advantages will become apparent from a consideration of the ensuing description and drawings.

### BRIEF DESCRIPTION OF THE DRAWINGS

FIG. 1 is a sectional view of a gas-solid separator incorporating with a transverse single drum type boiler according to a first preferred embodiment of the present invention.

FIG. 2 is a sectional view of a gas-solid separator incorporating with a transverse double drum type boiler according to a second preferred embodiment of the present invention.

FIG. 3 a sectional view of a gas-solid separator incorporating with a transverse single drum type boiler according to a third preferred embodiment of the present invention.

FIG. 4 is a sectional view of a gas-solid separator incorporating with a transverse double drum type boiler according to a fourth preferred embodiment of the present invention.

FIG. 5 a sectional view of a gas-solid separator incorporating with a transverse single drum type boiler according to a fifth preferred embodiment of the present invention.

FIG. 6 a sectional view of a gas-solid separator incorporating with a transverse single drum type boiler according to a sixth preferred embodiment of the present invention.

FIG. 7 is a sectional view of a gas-solid separator incorporating with a transverse double drum type boiler according to a seventh preferred embodiment of the present invention.

FIG. 8 a sectional view of a gas-solid separator incorporating with a transverse single drum type boiler according to an eighth preferred embodiment of the present invention.

FIG. 9 a sectional view of a gas-solid separator incorporating with a transverse single drum type boiler according to a ninth preferred embodiment of the present invention.

FIG. 10 a sectional view of a gas-solid separator incorporating with a transverse single drum type boiler according to a tenth preferred embodiment of the present invention.

FIG. 11 illustrates the flue direction of the gas-solid separator for gas-solid separation according to the above preferred embodiments of the present invention.

FIG. 12 is a sectional view of the gas-solid separator along a A-A sectional line of FIG. 11 according to the above preferred embodiments of the present invention.

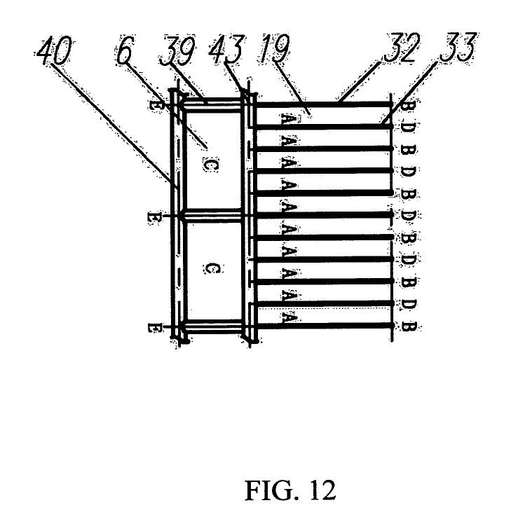

### DETAILED DESCRIPTION OF THE PREFERRED EMBODIMENT

Additional advantages and features of the invention will become apparent from the description which follows, and may be realized by means of the instrumentalities and combinations particular point out in the appended claims.

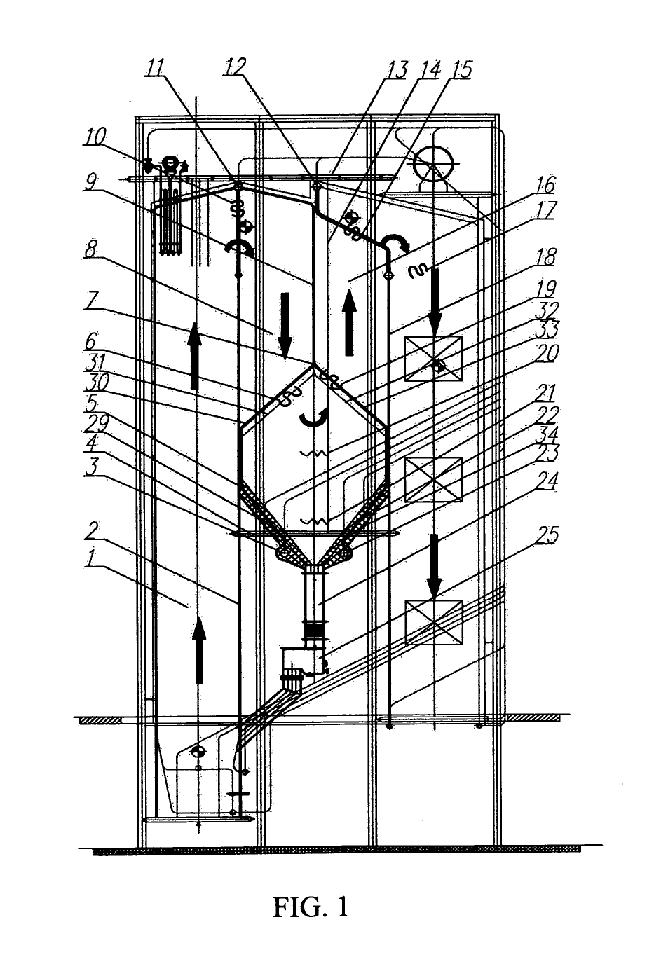

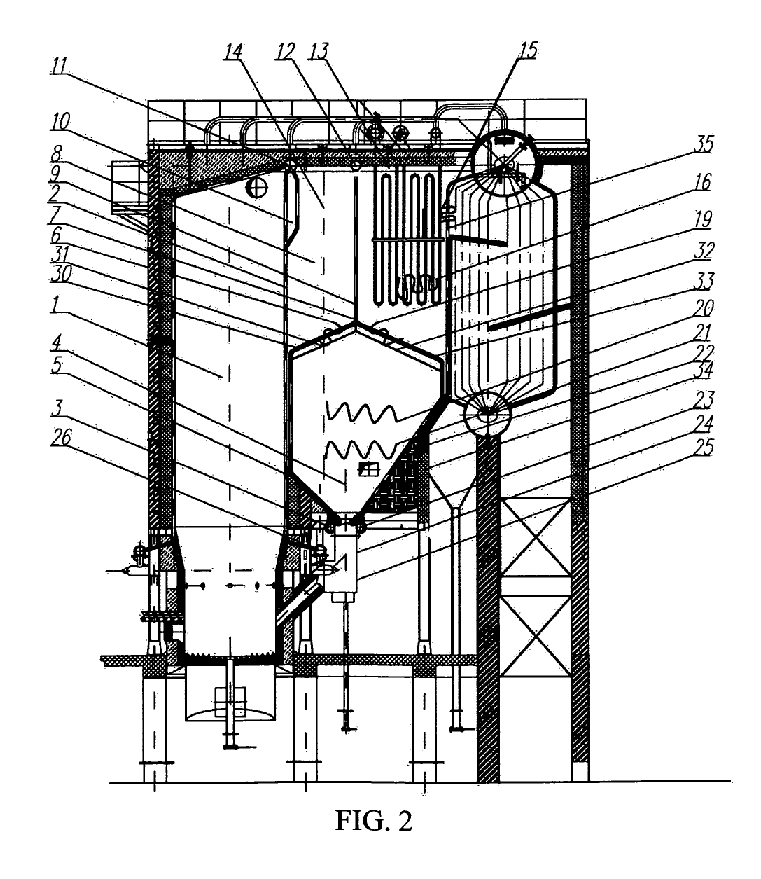

FIG. 1 illustrates a gas-solid separator incorporating with a boiler according to a first embodiment of the present invention, wherein the first embodiment illustrates how to incorporate the gas-solid separator with the boiler, such that the components of the boiler which are not directly related to the gas-solid separator will not be specifically introduced, and those components can be new or conventional components of the boiler. As shown in FIG. 1, the first embodiment comprises four main components i.e. a boiler furnace 1, a gas-solid separator, a vertical tunnel 17, and a feedback device (the feedback device in the first embodiment is a feedback valve 25), wherein the gas-solid separator is located at a separator space between a rear portion of the boiler furnace 1 and a front portion of the vertical tunnel 17. According to the first embodiment, the gas-separator comprises a film divider 9 as a screen panel formed at the separator space to divide the separator space into a first flue channel 8 at a front side of the separator space and a second channel 16 at a rear side of the separator space, wherein the flue at the first flue channel 8 is preferably at a downward flow direction while the flue at the second flue channel 16 is preferably at an upward flow direction such that the flow direction of the flue is turned at the bottom of the film divider 9 from the first flue channel 8 to the second flue channel 16. Accordingly, the film divider 9 is formed at the separator space at a position that the film divider 9 is provided at the middle of the rear wall 2 of the boiler furnace 1 and the front wall 18 of the vertical tunnel 17. It is appreciated that the film divider 9 can be either located slightly close to the rear wall 2 of the boiler furnace 1 (i.e. the cross sectional area of the second flue channel 16 is slightly larger than the cross sectional area of the first flue channel 8) or located significantly close to the rear wall 2 of the boiler furnace 1 (i.e. the cross sectional area of the second flue channel 16 is at least double to the cross sectional area of the first flue channel 8). According to the first embodiment, the film divider 9 is a single row membrane screen member, wherein the boiler comprises a top transverse tube collecting box 11 positioned at the top portion of the boiler furnace 1 above an flue outlet thereof, wherein the upper portion of the film divider 9 is linked to the top transverse tube collecting box 11 in an eccentrically and radially communicating manner. In other words, the upper portion of the film divider 9 is inclinedly extended from the top transverse tube collecting box 11 at a predetermined angle. The top transverse tube collecting box 11 is communicatively linked to the fuel guiding duct of the boiler (the fuel guiding duct is a common component of the boiler and is not shown in the figure). A film bifurcating unit 7 is defined at the bottom portion of the film divider 9 and is formed to bifurcate into two rows, i.e. front and rear rows (or can be three or more rows) of tube set (the number of rows of the tube set can be selectively configured and set in response to the flow rate of the flue). The first embodiment shows an example of using two rows of tube set. At the front row of the film bifurcating unit 7, the front-outer row tube set 30 and the front-inner row tube set 31 are configured in an intersecting manner. In other words, the front-inner row tube set 31 is positioned between two adjacent front-outer row tube set 30. The front-outer row tube set 30 is positioned between two adjacent front-inner row tube set 30. In addition, the front-outer row tube set 30 and the front-inner row tube set 31 form an even flow distributing tube set at an flue inlet 6 of a cornering channel 20, such that the gaps between the front-outer row tube set 30 and the front-inner row tube set 31 form the flue inlet 6 of the cornering channel 20. According to the first embodiment, the front-bottom portions of the front outer row tube set 30 and the front-inner row tube set 31 are biased against the rear wall 2 of the boiler furnace 1, wherein the two front rows of tube sets form a front vertical tube set extending downwardly. The bottom portion of the front vertical tube set is rearwardly and inwardly bent to form a slanted tube set as a collecting chamber front wall tube set 5, wherein the bottom portion of the collecting chamber front wall tube set 5 is linked to a front-chamber bottom transverse tube collecting box 3 at the bottom of a collecting chamber 21. According to the first embodiment, the inner and outer sides of the collecting chamber front wall tube set 5 are made of high temperature resistant material and are configured in a sealed manner, wherein the sealing structure of the collecting chamber front wall tube set 5 forms a collecting chamber front wall 29. At the rear row of the film bifurcating unit 7, the rear-inner row tube set 32 and the rear-outer row tube set 33 form an even flow distributing tube set at an flue outlet 19 of the cornering channel 20, such that the gaps between the rear-inner row tube set 32 and the rear-outer row tube set 33 form the flue outlet 19 of the cornering channel 20. According to the first embodiment, the rear-inner row tube set 32 and the rear-outer row tube set 33 are biased against the front wall 18 of the vertical tunnel 17, wherein the two rear rows of tube sets form a rear vertical tube set extending downwardly. The bottom portion of the rear vertical tube set is frontwardly and inwardly bent to form a slanted tube set as a collecting chamber rear wall tube set 22, wherein the bottom portion of the collecting chamber rear wall tube set 22 is linked to a rear-bottom transverse tube collecting box 23 at the bottom of the collecting chamber 21. According to the first embodiment, the inner and outer sides of the collecting chamber rear wall tube set 22 are made of high temperature resistant and heat insulated material and are configured in a sealed manner, wherein the sealing structure of the collecting chamber rear wall tube set 22 forms a collecting chamber rear wall 34. The inclination angles of the front collecting chamber tube wall 5 and the collecting chamber rear wall tube set 22 can be configured to achieve the solid blanking capability to the collecting chamber 21, wherein each inclination angle can be selectively adjusted. Accordingly, the vertical tube set is the collecting chamber rear wall tube set that the vertical tube set and the collecting chamber rear wall tube set are integrated with each other. The length of the vertical tube set ensures the deceleration of the flow rate of the flue at the expanded cornering channel, wherein the flow rate of the flue from the first flue channel to the expanded cornering channel will be significantly reduced, such that the flow rate of the flue at the first flue channel will be substantially slowed down at the cornering channel. Preferably, the flow rate of the flue at the first flue channel is doubled to the flow rate of the flue at the cornering channel, such that the solid particles in the flue will be maximizedly precipitated at the collecting chamber by means of gravity. It is worth mentioning that the length of the vertical tube set can be selectively adjusted to reduce the flow rate of the flue at the cornering channel. Accordingly, the cornering channel is formed at a space below the film bifurcating unit 7. The collecting chamber 21 is formed at a space between the bottom portion of the vertical tube set and the upper portion of the dipleg 24. According to the first embodiment, the upper portion of the dipleg 24 is operatively communicated with the collecting chamber 21 while the bottom portion of the dipleg 24 is operatively communicated with the boiler furnace 1 the feedback valve 25, such that the solid particles in the collecting chamber 21 can be transferred back to the boiler furnace 1 for combustion in a recycling manner. In particular, the feedback valve 25 is operatively coupled at the bottom portion of the dipleg 24. The collecting chamber 21 is formed in conical shape with the rectangular or square cross section. It is worth mentioning that the collecting chamber 21 can be formed by one or more conical units. When the collecting chamber 21 is formed by a plurality of conical units, the conical units are transversely aligned with each other, wherein the front-upper side of the collecting chamber 21 is biased against and sealed to the rear wall 2 of the boiler furnace 1 while the rear-upper side of the collecting chamber 21 is biased against and sealed to the front wall 18 of the vertical tunnel 17 (or the rear-upper side of the collecting chamber 21 is biased against the front row convection tube set 35, wherein the structure of the front row convection tube set 35 is shown in FIGS. 2, 4, and 7). In addition, the bottom portion of the collecting chamber 21 is communicatively and sealedly linked with one or more diplegs 24, wherein the interior of the collecting chamber 21 is divided into one or more trapezoidal shaped collecting compartments that the number of the collecting compartment matches with the number of the dipleg 24. In other words, the bottom portion of each of the collecting compartments is communicated and sealed with the upper portion of the corresponding dipleg 24. The feedback valve 25 is operatively coupled at each of the diplegs 24. According to the first embodiment, the front wall of the gas-solid separator is integrally formed at the rear wall 2 of the boiler furnace 1 while the rear wall of the gas-solid separator is integrally formed at the front wall 18 of the vertical tunnel 17 (or the rear-upper side of the collecting chamber 21 is biased against the front row convection tube set 35, wherein the structure of the front row convection tube set 35 is shown in FIGS. 2, 4, and 7). According to the first embodiment, the two sidewalls of the gas-solid separator are two symmetrical water-cooled walls 14, wherein the upper and bottom portions of the sidewalls are extended from the two symmetrical upper longitudinal tube collecting boxes 13 to the two symmetrical bottom longitudinal tube collecting boxes 4. According to the first embodiment, the upper symmetrical, longitudinal tube collecting boxes 13 are linked to the fuel guiding duct of the boiler. The bottom longitudinal tube collecting boxes 4 are lined to the down flowing duct of boiler. The fuel guiding duct and the down flowing duct are the common components of the boiler as the water cycling system, such that the fuel guiding duct and the down flowing duct are not shown in the figures. The film divider 9 is extended vertically to radially communicate with the bottom portion of the upper transverse tube collecting box 12 at either the concentric direction or the eccentric direction. The film divider 9 can also be extended its length and be bent to radially communicate with the top transverse tube collecting box 11. The gas-solid separator can be a full membrane wall structure; a half membrane wall structure, a partial membrane wall structure, a full light tube heat resistant drywall structure, or a heat resistant drywall structure.

The operation process of the first embodiment is that: the fluidized bed combustion is to combust the fuel in a fluidized state, wherein the fuel can be fossil fuel, industrial and agricultural waste, municipal solid waste or various low grade fuels, biomass combustion or a combustion mixture of biomass and coal. The heavy particles will be combusted at the bottom portion of the boiler furnace 1 while the fine particles will be combusted at the upper portion of the boiler furnace 1. The fine solid particles will be blown to the flue outlet 10 and guided by the film divider 9 such that the flue direction is detoured from the upper portion of the boiler furnace 1 to the first flue channel. Preferably, the flue direction at the boiler furnace 1 is vertically upward direction and the flue direction at the first flue channel is vertically downward direction, such that the flue direction is rapidly turned 180° from the boiler furnace 1 to the first flue channel. In particular, the flue is forced to rapidly straight down along the first flue channel 8 to the collecting chamber 21. The high concentrated solid particles are initially separated from the flue by the effects of the centrifugal force generated by the sharp turning direction and the gravitational pulling force. Thus, the efficiency of inertial gravity separation for the gas-solid separation will be further enhanced by the flow propelling force and the gravitational force of the solid particles to rapidly drop the solid particles into the collecting chamber. When the flue passes through the flue inlet 6 of the cornering channel, the flue will strike against the front-outer row tube set 30 and the front-inner row tube set 31, such that solid particles will hit twice thereat and will drop at the collecting chamber 21 so as to separate the solid particles from the flue. Since the cross section of the expanded cornering channel is larger than, preferably at least double, the cross section of the first flue channel, the flow rate of the flue will be dramatically reduced when entering to the expanded cornering channel. Therefore, the solid particles in the flue at the slow flow rate will be substantially precipitated into the collecting chamber 21 by gravity. The flue is then guided to exit the flue outlet 19 of the cornering channel, wherein the flue will strike to the rear-inner row tube set 32 and the rear-outer row tube set 33, such that solid particles will hit twice thereat and will drop at the collecting chamber 21. Preferably, the flue is guided to rapidly turn 180° from the flue inlet 6 of the cornering channel to the flue outlet 19 thereof. The flue will then be guided to flow along the second flue channel 16 at a relatively slow speed to the flue exit 15, wherein the flue direction at the second flue channel 16 is preferably vertically upward, such that the flue at the slow speed will prevent the solid particles being carried by the flow of flue again, so as to ensure all or almost all solid particles being separated from the flue. After the solid particles are collected in the collecting chamber 21, the solid particles are recycled and transferred back to the boiler furnace 1 via the dipleg 24 and the feedback valve 25. The solid particles in the circulating loop will be completely combusted and heat transferred. The flue without the solid particles will be exhausted at the vertical tunnel 17.

According to the first embodiment, when the flow rate of the flue is below a predetermined threshold, such as ≦5 m/s, of a slow circulating rate, wear protection should be partially applied at the first flue channel.

FIG. 2 illustrates a second embodiment, wherein the tube set at the flue inlet 6 and the tube set at the flue outlet 19 can be either asymmetrical or symmetrical and the collecting chamber front wall tube and the collecting chamber rear wall tube can be either asymmetrical or symmetrical. The structural configuration of the second embodiment is similar to that of the first embodiment. The differences between the first and second embodiments are: the boiler is the transverse double drum type boiler according to the second embodiment, the vertical tunnel is located at the bottom portion of the convection tube set that the size of the convection tube set is smaller than or is half of the vertical tunnel. The operation process of the second embodiment is the same as that of the first embodiment.

According to the second embodiment, the flow rate at the high dense area and at the low dense area of the boiler are that: higher than the circulating fluidizes bed boiler and below the low circulating rate, wherein the average rate at the first and second flue channel is between 3 m/s and 4 m/s, and the flow rate at the cornering channel is equal or less than 1.5 m/s. According the need of the boiler, the flow rate can be selectively regulated, wherein the water-cooled wall of the gas-solid separator can be fully exposed with partially wear-resistant treatment or can be fully exposed without any wear-resistant treatment. The second embodiment is the best mode of the boiler ≦35 T.

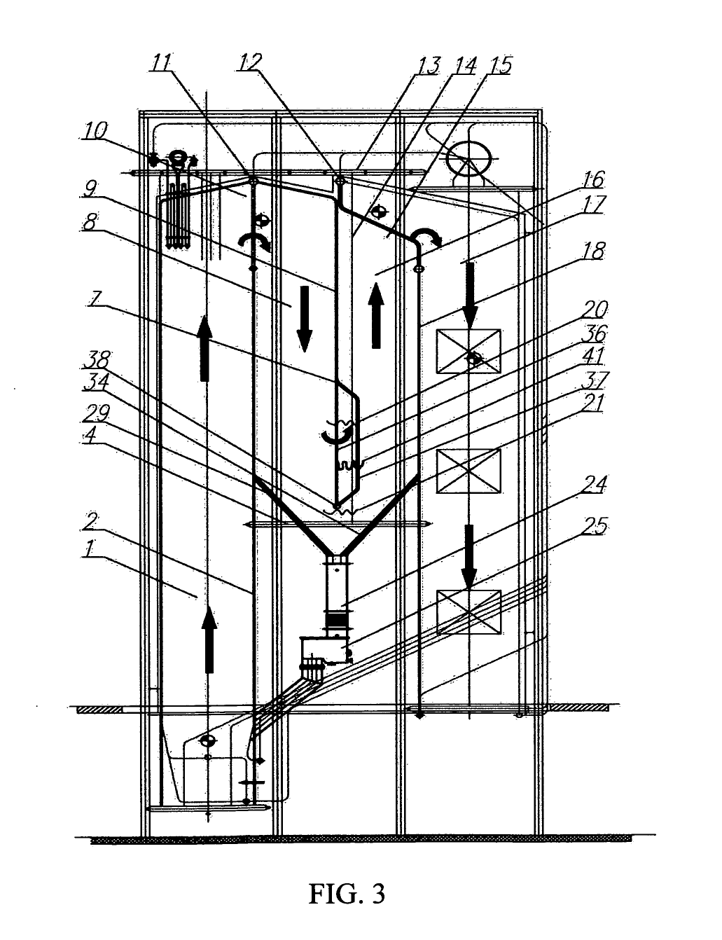

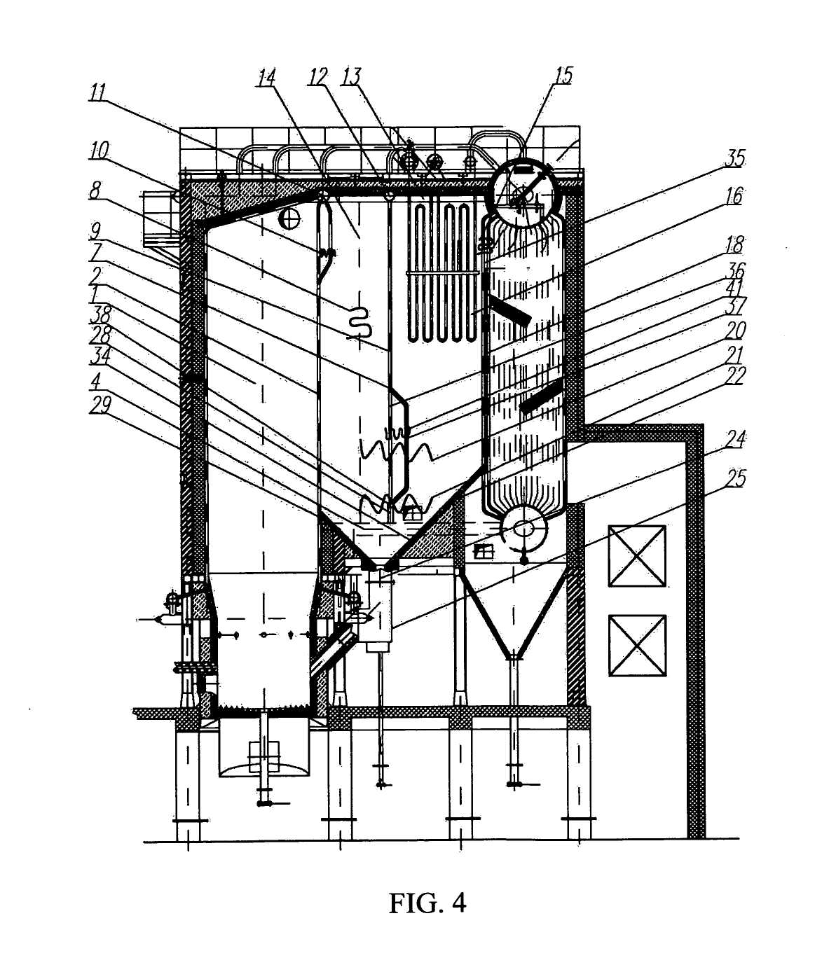

FIG. 3 illustrates a third embodiment, wherein the structural configuration of the third embodiment is similar to that of the first embodiment. The difference between the first and third embodiments is that the gas-solid separator further comprises a front row tube set 36 and a rear row tube set 37 located at the bottom of the film bifurcating unit 7 within the cornering channel or an additional tube set extending rearwardly. In particular, two rows of tube sets are extended from the bottom of the film bifurcating unit 7 (or three to five rows of tube sets are successively and rearwardly extended to the less dense area, wherein the longitudinal space between the tubes of the tube sets and the number of tube set determine and regulate the flow rate of the flue), wherein the bottom portion of the front tube set is extended to the upper portion of the tube set bottom transverse tube collecting box 38 while the rear row tube set 37 (the tube set rearwardly extended from the front row tube set 36 is the rear row tube set 37) is spaced apart from the front row tube set 36, wherein the bottom portion of the rear row tube set 37 is extended to the rear wall of the tube set bottom transverse tube collecting box 38 at the radial direction. According to the third embodiment, the rear row tube set 36 is divided into three sections; wherein the first section is the upper section rearwardly and inclinedly extended; the second section is the middle section vertically extended from the upper section for enabling the flue passing through the mid section in response to its length thereof, and the third section is the bottom section frontwardly and inclinedly extended from the mid section to the rear wall of the tube set bottom transverse tube collecting box 38 in a radial direction. The front row tube set 36 and the rear row tube set 37 form an even flow distributing tube set at the cornering channel 20. According to the third embodiment, the upper portion of the collecting chamber front wall 29 is biased against and sealed with the rear wall 2 of the boiler furnace 1 while the bottom portion of the collecting chamber front wall 29 is biased against and sealed with the upper portion of the dipleg 24. The upper portion of the collecting chamber rear wall 34 is biased against and sealed with the front wall 18 of the vertical tunnel 17 (as shown in FIG. 4, i.e. the fourth embodiment, the upper portion of the collecting chamber rear wall 34 is biased against the front row convection tube set 35). The bottom portion of the collecting chamber rear wall 34 is biased against and sealed with the upper portion of the dipleg 24, wherein the transverse distance is determined by the number of collecting chamber 21 and the dipleg 24. As shown in FIG. 4, the tube set bottom transverse tube collecting box 38 is linked to the bottom longitudinal tube collecting boxes 4 through the connecting tube 28.

The operation process of the third embodiment is that: the flue blown out of the flue outlet 10 is guided by the film divider 9 to flow at the first flue channel 8, preferably the flue is rapidly turned 180° to the first flue channel 8, toward the collecting chamber 21, such that the solid particles are separated from the flue by means of inertial gravity and are precipitated at the collecting chamber 21. The flue is then rapidly turned its direction, preferably at 180°, at the flue inlet 41 to separate the solid particles from the flue and to precipitate the solid particles at the collecting chamber 21. The flue will multiply strike to the front row tube set 36 and the rear row tube set 37, such that solid particles will drop at the collecting chamber 21 so as to separate the solid particles from the flue. After the solid particles are collected in the collecting chamber 21, the solid particles are recycled and transferred back to the boiler furnace 1 via the dipleg 24 and the feedback valve 25. The solid particles in the recycling loop will be completely combusted and heat transferred. The flue without the solid particles will be exhausted at the vertical tunnel 17.

The gas-solid separator of the third embodiment can work with the low temperature cyclone type of separator together, wherein the low temperature cyclone type of separator is installed within the vertical tunnel 17 during operation.

FIG. 4 illustrates a fourth embodiment, wherein the structural configuration of the fourth embodiment is similar to that of the second embodiment. The difference between the second and fourth embodiments is that the gas-solid separator further comprises a front row tube set 36 and a rear row tube set 37 located at the bottom of the film bifurcating unit 7 within the cornering channel or an additional tube set extending rearwardly. In particular, two rows of tube sets are extended from the bottom of the film bifurcating unit 7 (or three to five rows of tube sets are successively and rearwardly extended to the less dense area, wherein the longitudinal space between the tubes of the tube sets and the number of tube set determine and regulate the flow rate of the flue), wherein the bottom portion of the front tube set is extended to the upper portion of the tube set bottom transverse tube collecting box 38 while the rear row tube set 37 is spaced apart from the front row tube set 36, wherein the bottom portion of the rear row tube set 37 is extended to the rear wall of the tube set bottom transverse tube collecting box 38 at the radial direction. The front row tube set 36 and the rear row tube set 37 form an even flow distributing tube set at the cornering channel 20.

According to the fourth embodiment, the height of the connecting tube 28 can be increased to reach the depth of the cornering channel, wherein there is not tube set being configured at either the flue inlet or flue outer. The tube set bottom transverse tube collecting box 38 is replaced by the film bottom transverse tube collecting box 43.

The operation process of the fourth embodiment is the same as that of the third embodiment.

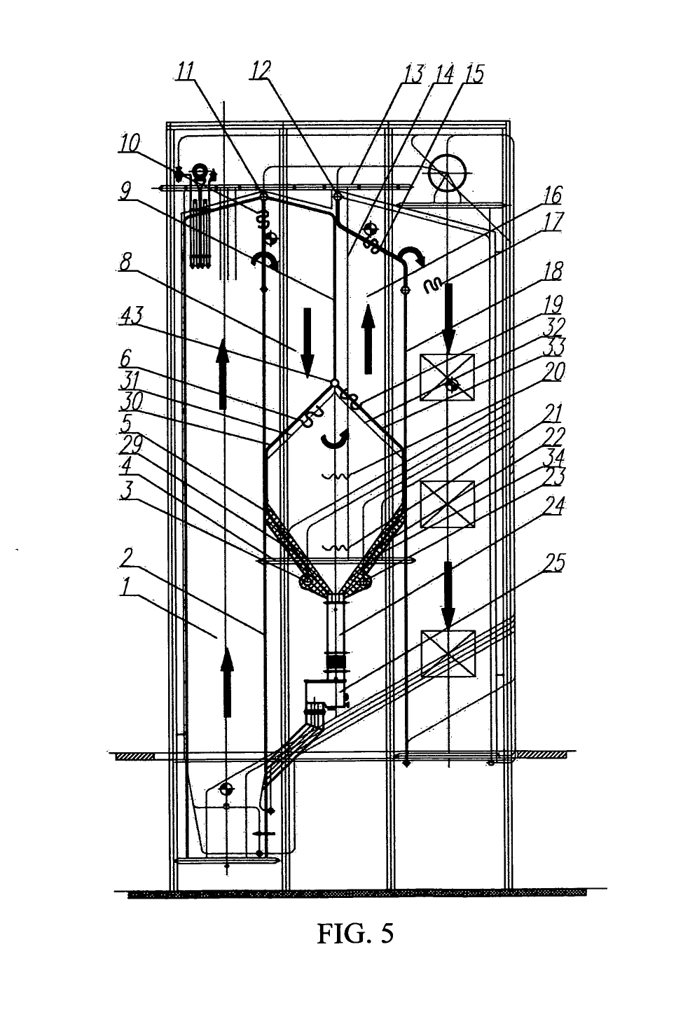

FIG. 5 illustrates a fifth embodiment, wherein the structural configuration of the fifth embodiment is similar to that of the first embodiment. The difference between the first and fifth embodiments is that the gas-solid separator further comprises a film bottom transverse tube collecting box 43 extended from the bottom portion of the film divider 9, wherein the front-inner row tube set 31 and the front-outer row tube set 30 are coupled with one side of the film bottom transverse tube collecting box 43 while the rear-inner row tube set 32 and the rear-outer row tube set 33 are coupled with another side of the film bottom transverse tube collecting box 43.

The operation process of the fifth embodiment is the same as that of the first embodiment.

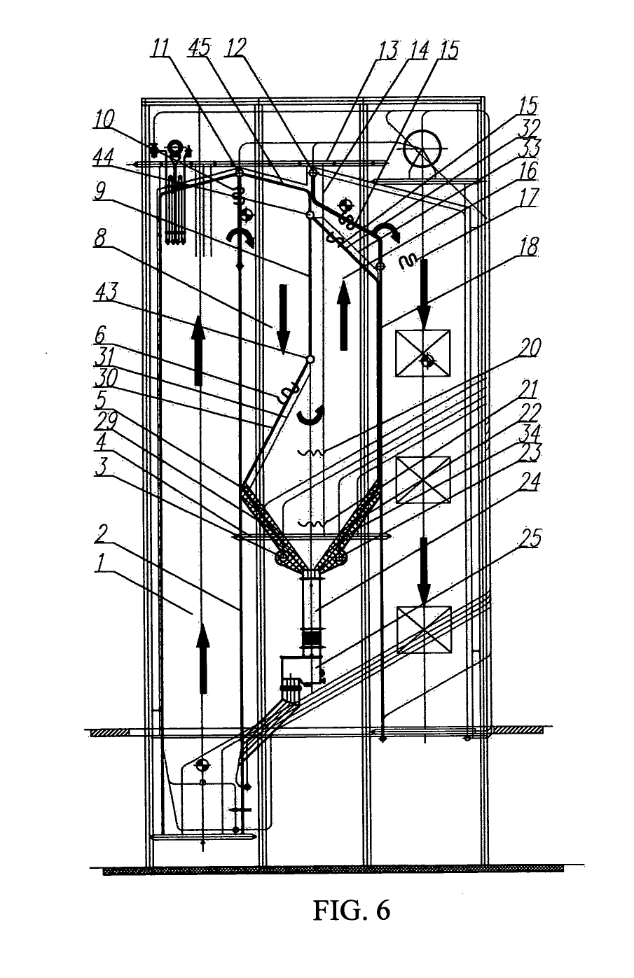

FIG. 6 illustrates a sixth embodiment, wherein the structural configuration of the sixth embodiment is similar to that of the fifth embodiment. The difference between the fifth and sixth embodiments is that the gas-solid separator further comprises a film upper transverse tube collecting box 44 provided at the film divider 9, wherein the upper portion of the film upper transverse tube collecting box 44 is linked to the bottom portion of the ceiling tube set 45 while the bottom portion of the film upper transverse tube collecting box 44 is linked to the upper portion of the film divider 9. Another difference between the fifth and sixth embodiments is that the upper portions of the rear-inner row tube set 32 and the rear-outer row tube set 30 at the flue outlet 19 of the cornering channel are operatively linked to the film upper transverse tube collecting box 44. According to the sixth embodiment, the tube diameter size of each the front-inner row tube set 31, the front-outer tube set 30, the front-chamber bottom transverse tube collecting box 3, and the film upper transverse tube collecting box 44 is larger than the tube size of those in the fifth embodiment.

The operation process of the fifth embodiment is similar to that of the first and fifth embodiments, except the flue passing through the flue outlet of the cornering channel to strike against the rear-inner row tube set 32 and the rear-outer row tube set 33, so as to rise to the flue outlet 15 of the second flue.

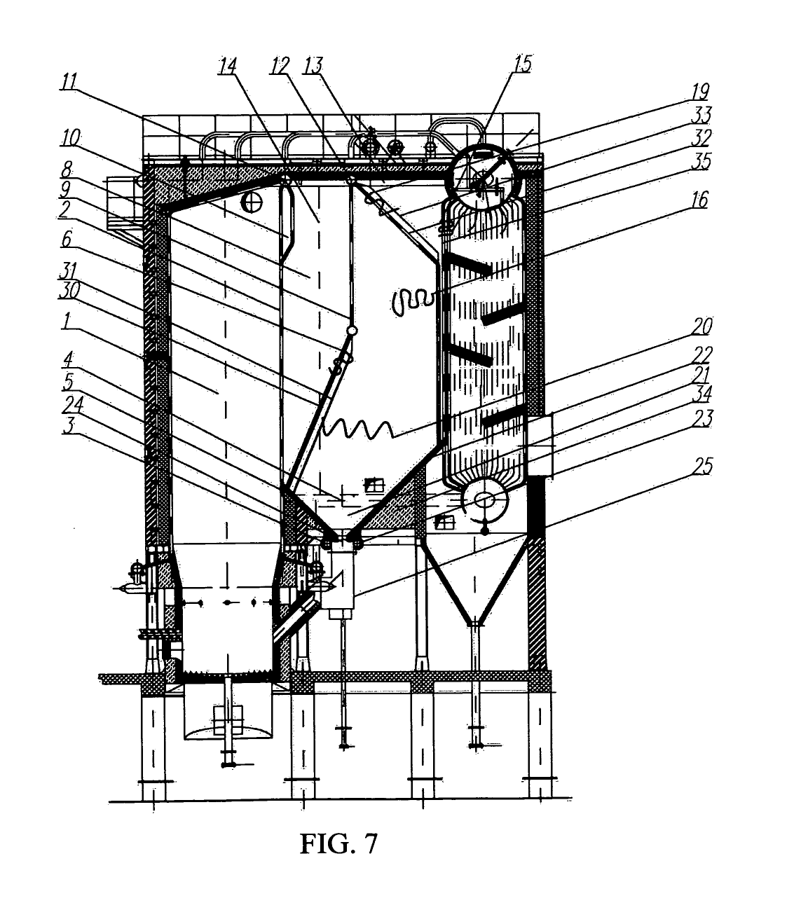

FIG. 7 illustrates a seventh embodiment, wherein the structural configuration of the seventh embodiment is similar to that of the sixth embodiment. The difference between the sixth and seventh embodiments is that the boiler is the transverse double drum type boiler according to the seventh embodiment, wherein the boiler does not contain any vertical tunnel and is suitable for low temperature steam. The boiler can be configured to have an air preheating device and to omit the coal economizer.

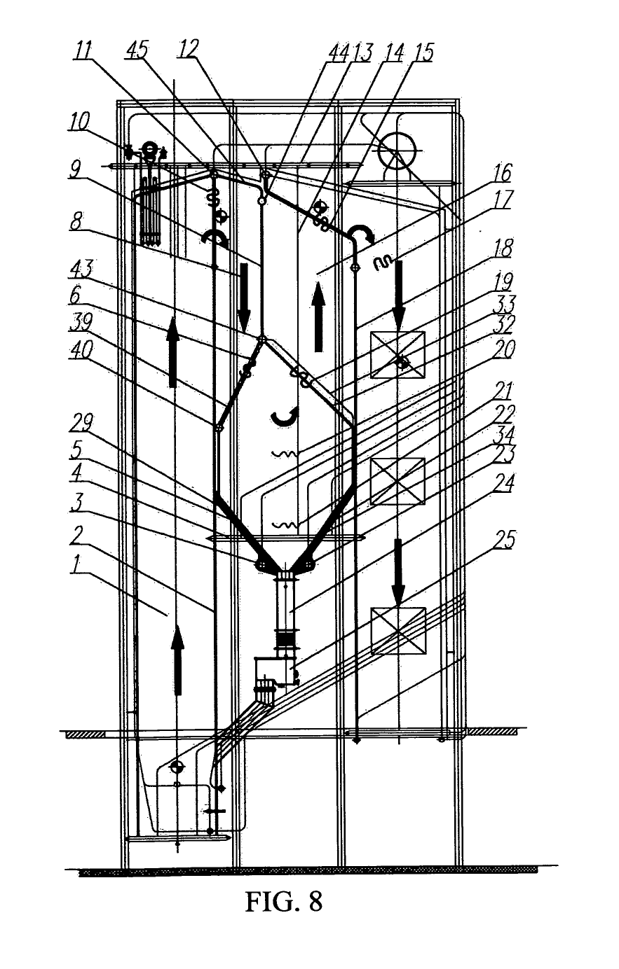

FIG. 8 illustrates an eighth embodiment, wherein the structural configuration of the eighth embodiment is similar to that of the fifth embodiment. The difference between the fifth and eighth embodiments is that that the gas-solid separator further comprises a film upper transverse tube collecting box 44 provided at the upper portion of the film divider 9, wherein the cross sectional area of the first flue channel 16 is smaller than the cross sectional area of the second flue channel 8 (according to the eight embodiment, the cross sectional area of the second flue channel 8 is about double the size of the cross sectional area of the first flue channel 16). Comparing with other embodiments that the cross sectional area of the second flue channel 8 is about the same size of the cross sectional area of the first flue channel 16, the flue rate at the first channel 8 will be dramatically increased while the flue rate at the second channel 16 will be dramatically reduced according to the eighth embodiment, so as to not only improve the precipitation of the solid particles through the expansion of the cornering channel and the inertial gravitation of the solid particles, but also prevent the solid particles being carried back by the flue at the second flue channel. Preferably, the low circulating rate at the first flue channel is equal or larger than 7M, the flue rate at the second flue channel is equal or lesser than 3M, the flue rate at the cornering channel is about 1.5M to 2.5M. Preferably, the high circulating rate at the first flue channel is equal or larger than 12M, the flue rate at the second flue channel is equal or lesser than 3M, the flue rate at the cornering channel is about 1.5M to 2.5M. Under the acceptable condition of the volume or the depth of the cornering channel 20, the flue rate should be configured to its acceptable lowest limit. According to the eighth embodiment, the gas-solid separator further comprises a connecting tube transverse tube collecting box 40 provided at the front-bottom portion of the flue inlet 6 of the cornering channel, wherein the front-inner tube set 31 and the front-outer tube set 30 are replaced by the wear resistant connecting tube 39. The upper portion of the wear resistant connecting tube 39 is operatively linked to the film bottom transverse tube collecting box 43 while the bottom portion of the wear resistant connecting tube 39 is operatively linked to the connecting tube transverse tube collecting box 40. The main function of the wear resistant connecting tube 39 is to enable the water cycling of the collecting chamber front wall tube. According to the eighth embodiment, the tube diameter size of the wear resistant connecting tube 39 must be equal or lesser than the tube diameter size of each of the film bottom transverse tube collecting box 43 and the connecting tube transverse tube collecting box 40. The eighth embodiment is the best mode of the boiler ≦35 T. The full path of the first flue channel contains four wear resistant wall tube sets.

According to the eighth embodiment, all collected data are theoretical and empirical data but not the restrictive data. For implementation, the configuration of the gas-solid separator can be specifically designed and modified to enhance the flexibility of the actual use of the gas-solid separator.

The operation process of the eighth embodiment is the same as that of the first and fifth embodiments.

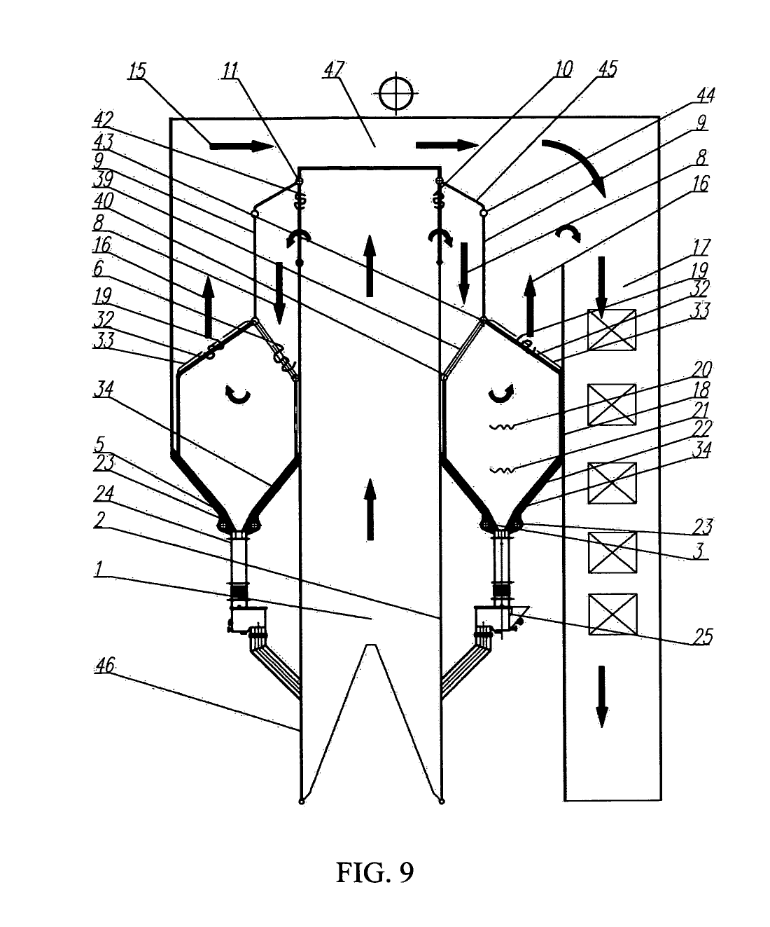

FIG. 9 illustrates a ninth embodiment, wherein the structural configuration of the ninth embodiment is similar to that of the eighth embodiment. The difference between the eighth and ninth embodiments is that an additional gas-solid separator is further provided at the front side of the front wall 26 of the boiler furnace 1, wherein the gas-solid separator at the front side of the front wall 26 of the boiler furnace 1 is identical and symmetrical to the gas-solid separator at the rear side of the rear wall 2 of the boiler furnace 1. In other words, two gas-solid separator are utilized in the boiler, wherein a longitudinal guiding channel 27 is formed at the upper portion of the boiler toward the vertical tunnel 17 for guiding the flue flow. The ninth embodiment is suitable for large scale of boiler having a relatively huge and deep furnace.

The gas-solid separator in the ninth embodiment can be configured as the gas-solid separator in the eighth embodiment, or as the gas-solid separator with certain components or certain structures in the first to seventh embodiments.

The wear resistant application in the ninth embodiment is the same as that in the eighth embodiment.

The difference between the operation process of the ninth embodiment and the operation process of the eighth embodiment is that the flue passes through the flue outlets 10, 42 of the boiler furnace 1 concurrently to the first flue channel 8, wherein the flue passes through the gas-solid separator at the front side of the front wall 26 of the boiler furnace 1, enters into the longitudinal guiding channel 27 at the upper portion of the boiler through the second flue channel 16, and rearwardly flows to the vertical tunnel 17.

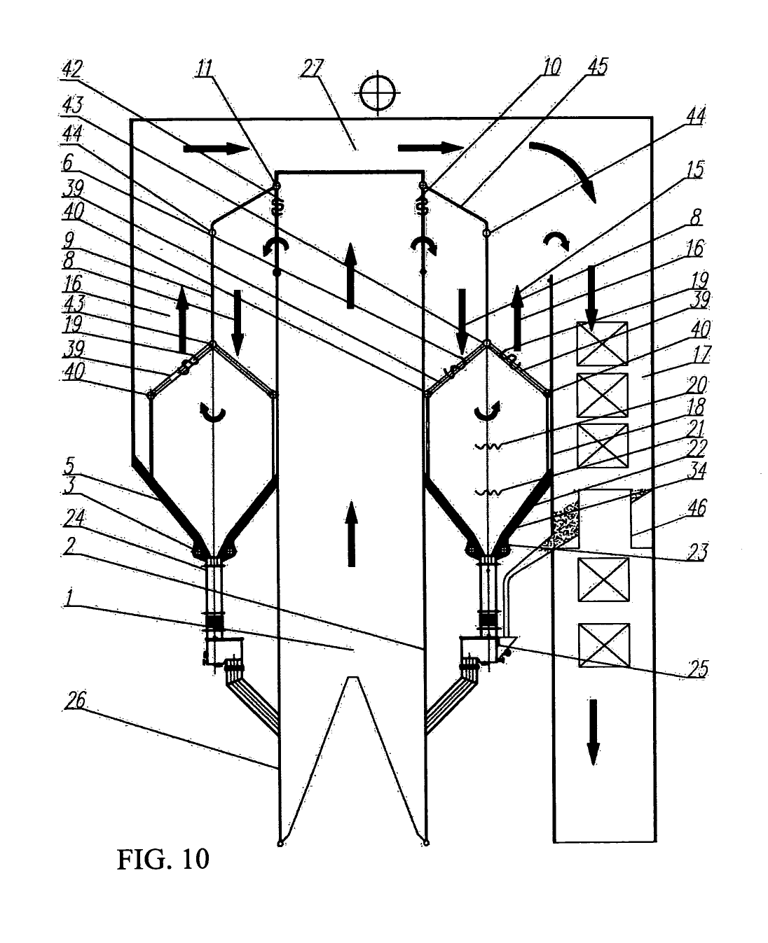

FIG. 10 illustrates a tenth embodiment, wherein the structural configuration of the tenth embodiment is similar to that of the ninth embodiment. The difference between the ninth and tenth embodiments is that the cross sectional area of the first flue channel 16 is identical and symmetrical to the cross sectional area of the second flue channel 8. The wear resistant connecting tube 39 and the connecting tube transverse tube collecting box 40 at the flue inlet 6 and the flue outlet 19 of the cornering channel are symmetrical. The upper portion of the wear resistant connecting tube 39 at the flue inlet 6 of the cornering channel is operatively linked to the film bottom transverse tube collecting box 43. The bottom portion of the wear resistant connecting tube 39 at the flue inlet 6 of the cornering channel is biased against the front wall 17 of the vertical tunnel or is slightly spaced apart from the front wall 17 of the vertical tunnel to operatively link to the connecting tube transverse tube collecting box 40. According to the tenth embodiment, the tube diameter size of the wear resistant connecting tube 39 must be smaller than that of the transverse tube collecting box in which the wear resistant connecting tube 39 is connected thereto. Since the flue outlet of the cornering channel is expanded in its size to substantially reduce the solid particles within the flue, the tube diameter size of the wear resistant connecting tube 39 can be substantially reduced. Therefore, by appropriately increasing the density of the flue to enhance the gas-solid separation performance, the flow rate of the flue can be ensured by providing enough space to flow therethrough even without the wear resistant ability. A cyclone type separator is provided within the vertical tunnel to incorporate with the two gas-solid separators.

According to the tenth embodiment, the entire path of the first flue channel has the wear resistant treatment. The wear resistant treatment can be partially applied to the second flue channel depending the actual operation of the gas-solid separator.

The operation process of the tenth embodiment is the same as that of the ninth embodiment.

According to the first to tenth embodiments, the rear wall of the gas-solid separator is integrally formed with the front wall of the vertical tunnel. The water circulating system between the rear wall of the boiler furnace and the front wall of the vertical tunnel is a conventional water circulating system. Two sidewalls of the gas-solid separator are integrally formed with two symmetrical water-cooled walls. The upper portions of the symmetrical water-cooled walls are operatively linked to the bottom longitudinal tube collecting box while the bottom portions of the symmetrical water-cooled walls are operatively linked to the upper longitudinal tube collecting box. The down flowing duct of the boiler is operatively linked to the bottom longitudinal tube collecting box, wherein the fuel guiding duct of the boiler is operatively linked to the upper longitudinal tube collecting box.

The water circulation of the gas-solid separator starts from the two water-cooled sidewalls which are between the down flowing duct of the boiler and the bottom transverse tube collecting box upwardly to the upper transverse tube collecting box, and then enters into the boiler through the fuel guiding duct. The down flowing duct of the boiler is operatively linked to the collecting chamber transverse tube collecting box to upwardly guide the hot water to the film bottom transverse heater through the collecting chamber wall tube and the vertical tube set. The hot water is then guided to flow upwardly to the film tube set and subsequently to the film upper transverse tube collecting box. The hot water will be entered into the boiler through the fuel guiding duct.

According to the first to tenth embodiment, the gas-solid separator of the present invention should be a high range temperature gas-solid separator for the boiler ≧35 T, wherein the temperature at the flue outlet of the boiler furnace should be increased and the performance of solid precipitation should be enhanced to improve the heat convection and complete combustion. The gas-solid separator of the present invention should be a low range temperature or mid range temperature gas-solid separator for the boiler ≦35 T in order to reduce the height of the boiler.

According to the tenth embodiment, the structural configurations and components can be further modified to optimize the performance of the gas-solid separator so as to continuously improve and expand the use of the gas-solid separator.

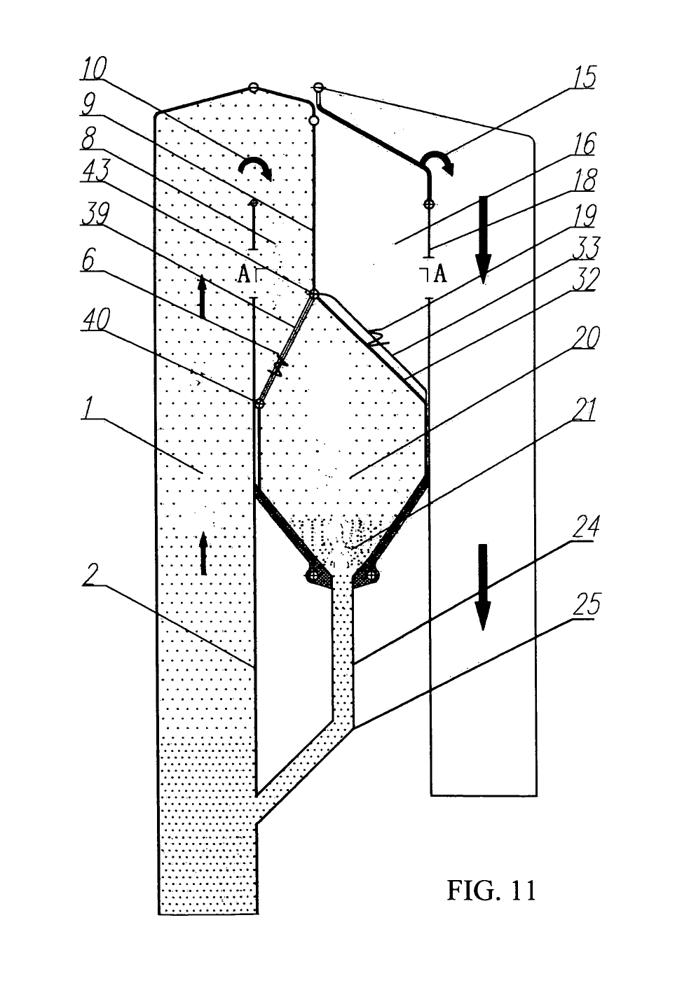

FIG. 11 illustrates the flow of the operation of the gas-solid separator, wherein the fuel is combusted in a fluidized manner in the circulating fluidized bed boiler, wherein the fuel can be fossil fuel, industrial and agricultural waste, municipal solid waste or various low grade fuels, biomass combustion or a combustion mixture of biomass and coal. The heavy particles will be combusted at the bottom portion of the boiler furnace 1 while the fine particles will be combusted at the upper portion of the boiler furnace 1. The fine particles will be blown to the flue outlet 10 and guided by the film divider 9 such that the flue direction is detoured from the upper portion of the boiler furnace 1 to the first flue channel. Preferably, the flue direction at the boiler furnace 1 is vertically upward direction and the flue direction at the first flue channel is vertically downward direction, such that the flue direction is rapidly turned 180° from the boiler furnace 1 to the first flue channel. In particular, the flue is forced to rapidly straight down along the first flue channel 8 to the collecting chamber 21. The high concentrated solid particles are initially separated from the flue by the effects of the centrifugal force generated by the sharp turning direction and the gravitational pulling force. Thus, the efficiency of inertial gravity separation for the solid separation will be further enhanced by the flow propelling force and the gravitational force of the solid particles. When the flue passes through the flue inlet 6 of the cornering channel, the flue will strike against the front-outer row tube set 30 and the front-inner row tube set 31, such that solid particles will hit twice thereat and will drop at the collecting chamber 21 so as to separate the solid particles from the flue. Since the cross section of the expanded cornering channel is larger than, preferably at least double, the cross section of the first flue channel, the flow rate of the flue will be dramatically reduced when entering to the expanded cornering channel. Therefore, the solid particles in the flue at the slow flow rate will be substantially precipitated into the collecting chamber 21 by gravity. The flue is then guided to exit the flue outlet 19 of the cornering channel, wherein the flue will strike to the rear-inner row tube set 32 and the rear-outer row tube set 33, such that solid particles will hit twice thereat and will drop at the collecting chamber 21. Preferably, the flue is guided to rapidly turn 180° from the flue inlet 6 of the cornering channel to the flue outlet 19 thereof. The flue will then be guided to flow along the second flue channel 16 at a relatively slow speed to the flue exit 15, wherein the flue direction at the second flue channel 16 is preferably vertically upward, such that the flue at the slow speed will prevent the solid particles being carried by the flow of flue again, so as to ensure all or almost all solid particles being separated from the flue. After the solid particles are collected in the collecting chamber 21, the solid particles are recycled and transferred back to the boiler furnace 1 via the dipleg 24 and the feedback valve 25. The solid particles in the circulating loop will be completely combusted and heat transferred. The flue without the solid particles will be exhausted at the vertical tunnel 17.

One skilled in the art will understand that the embodiment of the present invention as shown in the drawings and described above is exemplary only and not intended to be limiting. It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A circulating fluidized bed boiler, comprising a gas-solid separator which a film divider, a first flue channel, a second flue channel, a cornering channel, a collecting chamber, a flue inlet provided at a front upper portion of said gas-solid separator, a flue outlet provided at a rear upper portion of said gas-solid separator, wherein said film divider is provided at a separator space to divide said separator space into said first and second flue channels, wherein said cornering channel is communicatively linked between said first and second flue channels such that a flow direction of flue is detoured and changed from said first flue channel to said second flue channel through said cornering channel, wherein said collecting chamber is provided at a bottom portion of said cornering channel and is communicatively linked to dipleg via a feedback valve.

2. The circulating fluidized bed boiler, as recited in claim 1, wherein said gas-solid separator further comprises an even flow distributing tube set defined at a bottom portion of said film divider.

3. The circulating fluidized bed boiler, as recited in claim 1, further comprising a boiler furnace and a vertical tunnel, wherein said gas-solid separator is positioned between said boiler furnace and said vertical tunnel that said flue inlet of said gas-solid separator is communicatively linked to an upper portion of said boiler furnace while said flue outlet of said gas-solid separator is communicatively linked to an upper portion of said vertical tunnel, wherein said dipleg and said feedback valve are communicatively linked to a bottom portion of said boiler furnace.

4. The circulating fluidized bed boiler, as recited in claim 3, wherein said gas-solid separator further comprises an even flow distributing tube set defined at a bottom portion of said film divider at a position that said even flow distributing tube set is provided at one side or two sides of the film divider to form a flue inlet and/or a flue outlet of said cornering channel, wherein an upper portion of said even flow distributing tube set is operatively linked to said film divider while a bottom portion of said even flow distributing tube set is operatively linked to one of a collecting chamber bottom transverse tube collecting box or a tube set bottom transverse tube collecting box within said cornering channel, wherein said collecting chamber bottom transverse tube collecting box is operatively linked to a down flowing duct of said boiler.

5. The circulating fluidized bed boiler, as recited in claim 4, wherein said film divider is configured to form a single row tube set, wherein a bottom portion of said single row tube set of said film divider is bifurcated to form a front row tube set having two or more rows of tube sets, and a rear row tube set having two or more rows of tube sets, wherein said front and rear rows tube sets are evenly extended above said collecting chamber to form said flue inlet and said flue outlet of said cornering channel, wherein said front and rear rows tube sets are also formed as said even flow distributing tube sets at said flue inlet and said flue outlet of said cornering channel, wherein said front row tube set is frontwardly and inclinedly extended to a rear wall of said boiler furnace, wherein said multiple rows of said front row tube set are merged into a single row and are vertically bent to form a front vertical tube set, wherein said rear row tube set is rearwardly and inclinedly extended to a front wall of said vertical tunnel, wherein said multiple rows of said rear row tube set are merged into a single row and are vertically bent to form a rear vertical tube set, wherein a bottom portion of said rear vertical tube set is inwardly bent to further rearwardly extend that said bottom portion thereof is operatively linked to said collecting chamber bottom transverse tube collecting box, wherein said bottom portion of said rear vertical tube set forms an inclined tube set as said collecting chamber tube wall, such that said collecting chamber tube wall is integrally formed with said rear vertical tube set.

6. The circulating fluidized bed boiler, as recited in claim 4, wherein said gas-solid separator further comprise a film bottom transverse tube collecting box at said bottom portion of the film divider, wherein said film divider is operatively linked to said film bottom transverse tube collecting box, wherein said gas-solid separator further comprises a film upper transverse tube collecting box at an upper portion of said film divider, wherein said film divider is operatively linked to said film upper transverse tube collecting box, wherein an upper portion of said even flow distributing tube set within said cornering channel is operatively linked to said film bottom transverse tube collecting box.

7. The circulating fluidized bed boiler, as recited in claim 6, wherein said upper portion of said even flow distributing tube set at said flue outlet of said second flue channel is operatively linked to one of said film upper transverse tube collecting box and said upper transverse tube collecting box at said upper side of the gas-solid separator, wherein said upper transverse tube collecting box is operatively linked to a fuel guiding duct of said boiler, wherein said bottom portion of said even flow distributing tube set at said flue outlet of said second flue channel is biased against said front wall of said vertical tunnel or said bottom portion of said even flow distributing tube set is spaced apart from said front wall of said vertical tunnel to form a downwardly vertical tube set, wherein said bottom portion of said downwardly vertical tube set is inwardly bent to form said inclined tube set as said collecting chamber wall tube, wherein said inclined tube set of said collecting chamber wall tube is operatively linked to said collecting chamber bottom transverse tube collecting box.

8. The circulating fluidized bed boiler, as in one of claims 3-7, wherein said film divider is formed at said separator space at a position according to a need of said boiler, wherein said film divider is provided at one of positions that said film divider is provided at the middle of said rear wall of said boiler furnace and said front wall of the vertical tunnel, said film divider is located slightly close to said rear wall of said boiler furnace, and said film divider is located significantly close to said rear wall of said boiler furnace.

9. The circulating fluidized bed boiler, as in one of claims 4-7, wherein when a flow rate of flue at said first flue channel is greater than 5 m/s, a wear resistant connecting tube is used for said even flow distributing tube set at said cornering channel.

10. The circulating fluidized bed boiler, as in one of claims 3-7, wherein said film divider and the four surrounding walls of said gas-solid separator are configured selected from the group consisting of a full membrane wall structure, a half membrane wall structure, a partial membrane wall structure, a full light tube heat resistant drywall structure, and a heat resistant drywall structure.

11. The circulating fluidized bed boiler, as in one of claims 3-7, wherein an interior and/or exterior shape of said gas-solid separator is one of rectangular, square, circular, oval, and polygonal shape.

12. The circulating fluidized bed boiler, as in one of claims 3-7, wherein said front wall of said gas-solid separator is configured selected from the group consisting of said front wall of said gas-solid separator is integrally formed at said rear wall of said boiler furnace, said front wall of said gas-solid separator is an individual film membrane wall structure, said front wall of said gas-solid separator is a water cooled wall structure, wherein said rear wall of the gas-solid separator is configured selected from the group consisting of said rear wall of the gas-solid separator is integrally formed at the front wall of the vertical tunnel, said rear wall of the gas-solid separator is an individual film membrane wall structure, and said rear wall of the gas-solid separator is a water cooled wall structure, wherein two sidewalls of said gas-solid separator are configured selected from the group consisting of two symmetrical film membrane wall structures and two symmetrical water-cooled walls, wherein upper and bottom portions of said sidewalls are extended from two symmetrical upper longitudinal tube collecting boxes to two symmetrical bottom longitudinal tube collecting boxes, wherein said upper symmetrical longitudinal tube collecting boxes are linked to a fuel guiding duct of said boiler, wherein said bottom longitudinal tube collecting boxes are linked to said down flowing duct of said boiler.

13. A gas-solid separation method, comprising the step of configuring three flowing paths as a first flue channel, a second flue channel, and a cornering channel, regulating different flow rates of flue at said three flowing paths, increasing said flow rate of flue at said first flue channel, expanding a flow area of said expanded cornering channel with respect to said first flue channel to decelerate said flow rate of flue at said expanded cornering channel so as to enhance an inertial separation force and gravitational precipitation force of solid particles within said flue, and minimizing said flow rate at said second flue channel for minimizing said solid particles being dragged by said flow of flue at said second flue channel so as to prevent fine solid particles not being dragged again into said flue when said flow of flue is guided along said second flue channel, wherein said film divider is arranged for guiding said flue with fine solid particles to detour the flue direction from a flue outlet of a boiler furnace to said first flue channel that the flue direction at said boiler furnace is vertically upward direction and the flue direction at said first flue channel is vertically downward direction, such that said flue direction is rapidly turned 180° from said boiler furnace to said first flue channel, wherein said flue is forced to rapidly straight down along said first flue channel to a collecting chamber at a bottom portion of said cornering channel, wherein the cross section of said expanded cornering channel is larger than the cross section of said first flue channel, such that said flow rate of said flue is dramatically reduced when entering to said expanded cornering channel, wherein the high density of said solid particles in said flue at said slow flow rate is substantially precipitated into said collecting chamber by gravity, wherein the flue direction of said flue is rapidly turned at said gas-solid separator twice at two 180° sharp turns, to separate said solid particles from said flue by inertial separation so as to precipitate said solid particles at said collecting chamber.

14. The method, as recited in claim 13, further comprising a step of guiding said flow of flue to strike against an even flow distributing tube sets to separate said solid particles from said flue by inertial separation so as to precipitate said solid particles at said collecting chamber after said flow of flue is guided to rapidly turned twice.
